(19) United States
(12) Patent Application Publication
(10) Pub. No.: US 2025/0116147 A1
(43) Pub. Date: Apr. 10, 2025

(54) ADVANCED REAR GATE ACCESS SYSTEM

(71) Applicant: FCA US LLC, Auburn Hills, MI (US)

(72) Inventors: Randy Gerken, White Lake, MI (US); Mara Tonietti, Modena (IT); Ian J. Komisak, Sterling Heights, MI (US); Evan Oswald, Auburn Hills, MI (US)

(21) Appl. No.: 18/481,269

(22) Filed: Oct. 5, 2023

(51) Int. Cl. E05F 15/40; B60J 5/10

(52) U.S. Cl. CPC E05F 15/40; E05Y 2400/44; E05Y 2400/54; E05Y 2900/546

(57) ABSTRACT

A system and method of operating a rear closure assembly mounted to a rear portion of a vehicle is provided. The method includes receiving data indicative of a whether an object is detected near the rear portion of the vehicle; determining whether the detected object will obstruct the rear closure assembly from moving between a closed position to a maximum open position based on the data; and providing a response to an operator of the vehicle when the rear closure assembly will be obstructed from moving between the closed position to the maximum open position.

### FIELD

The present disclosure relates to a vehicle system, more specifically to an advanced rear gate access system.

### BACKGROUND

This section provides background information related to the present disclosure which is not necessarily prior art.

Vehicles today come with a variety of parking assist systems and packages to help drivers navigate reverse parking (e.g., backing into a space, in order to drive forward out of the space afterwards). Some drivers simply prefer reverse parking compared to forward parking into a parking space because it reduces the risk of collisions that may occur while backing out of a parking space.

Reverse parking, however, can also come with its unique set of challenges. For example, when reverse parking, a driver may not be aware of the distance between the rear of the vehicle and an obstacle facing the rear. As a result, the driver may park too close to an obstacle, preventing the driver from fully opening rear life gate to access a cargo area of the vehicle. This may be an inconvenience to the driver who has to travel to the rear of the vehicle only to find that they must reposition the vehicle in the parking space to access the cargo area of the vehicle. This situation can cost the driver both time and effort.

The present disclosure addresses these issues and others.

### SUMMARY

This section provides a general summary of the disclosure and is not a comprehensive disclosure of its full scope or all of its features.

According to a first aspect of the present disclosure, there is provided a vehicle that includes a vehicle body having a front portion and a rear portion; a movable enclosure attached to the rear portion of the vehicle that is configured to move between a closed position and a maximum open position; and a movable enclosure access system that is configured to determine whether an object is located proximate to the rear portion of the vehicle that would inhibit the movable enclosure from moving between the closed position and the maximum open position, wherein the movable enclosure access system includes at least one sensor that is configured to generate a signal indicative of a distance between the object and the rear portion of the vehicle; the movable enclosure access system includes an object detection module including a memory and a processor that is in communication with the at least one sensor; and based on the signal indicative of the distance between the object and the rear portion of the vehicle, the objection detection module is configured to determine whether the distance between the object and the rear portion of the vehicle is sufficient to permit the movable enclosure to move between the closed position and the maximum open position without contacting the object.

According to the first aspect, the movable enclosure access system further includes a camera and a display device configured to display images captured by the camera.

According to the first aspect, in addition to the images captured by the camera, the display device is configured to display an obstruction indicator that is configured to provide a visual indication of whether the distance between the object and the rear portion of the vehicle is sufficient to permit the movable enclosure to move between the closed position and the maximum open position without contacting the object.

According to the first aspect, the obstruction indicator includes at least three visual color zones.

According to the first aspect, the vehicle further includes a controller in communication with a driving mechanism that, based on an instruction received from the controller, is configured to move the movable enclosure between the closed and maximum open positions; the controller is in communication with the object detection module; the objection detection module is configured to communicate the determination whether the distance between the object and the rear portion of the vehicle is sufficient to permit the movable enclosure to move between the closed position and the maximum open position without contacting the object; and based on the communication received from the objection detection module, the controller is configured to permit or prevent the movable enclosure from moving between closed position and the maximum open position.

According to the first aspect, the movable enclosure access system includes a data storage that stores an algorithm and that can be accessed and executed by the processor, and when the algorithm is executed by the processor, the objection detection module is configured to determine whether the movable enclosure will contact the object when movable enclosure is moved between the closed position to the maximum open position.

According to the first aspect, the data storage is configured to store information directed to dimensions of the movable enclosure.

According to the first aspect, the at least one sensor includes an ultrasonic sensor configured to emit ultrasonic waves and receive ultrasonic waves reflected by the object to generate the signal indicative of the distance between the object and the rear portion of the vehicle.

According to the first aspect, the at least one sensor includes a radar sensor configured to emit electromagnetic waves and receive electromagnetic waves reflected by the object to generate the signal indicative of the distance between the object and the rear portion of the vehicle.

According to a second aspect of the present disclosure, there is provided a method of operating a movable enclosure attached to a rear portion of a vehicle that is configured to move between a closed position and an open position, the method includes determining whether the vehicle is moving in reverse; after determining that the vehicle is moving in reverse, activating at least one sensor located at the rear portion of the vehicle to determine whether an object is present at a location proximate the rear portion of the vehicle and generate a signal indicative of a distance between the rear portion of the vehicle and the object; and based on the signal indicative of the distance between the rear portion of the vehicle and the object, determining whether the distance is sufficient to permit the movable enclosure to move between the closed position and the open position without contacting the object.

According to the second aspect, after determining whether the vehicle is moving in reverse, the method may further include activating a camera to obtain images and a display device configured to display images captured by the camera.

According to the second aspect, in addition to displaying images captured by the camera, the method includes displaying on the display device an obstruction indicator that is configured to provide a visual indication of whether the distance between the object and the rear portion of the vehicle is sufficient to permit the movable enclosure to move between the closed position and the maximum open position without contacting the object.

According to the second aspect, the obstruction indicator includes at least three visual color zones.

According to the second aspect, after determining whether the distance is sufficient to permit the movable enclosure to move between the closed position and the open position without contacting the object, the method further comprises communicating a signal to a controller in communication with a driving mechanism that, based on an instruction received from the controller, is configured to move the movable enclosure between the closed and maximum open positions, wherein if the signal communicated to the controller indicates that the distance between the object and the rear portion of the vehicle is sufficient to permit the movable enclosure to move between the closed position and the maximum open position without contacting the object, the controller is permitted to instruct the driving mechanism to move the movable enclosure, and if the distance between the object and the rear portion of the vehicle is insufficient to permit the movable enclosure to move between the closed position and the maximum open position, the controller is not permitted to instruct the driving mechanism to move the movable enclosure.

According to the second aspect, activating the at least one sensor includes emitting ultrasonic waves and receiving ultrasonic waves reflected by the object to generate the signal indicative of the distance between the object and the rear portion of the vehicle.

According to the second aspect, activating the at least one sensor includes emitting electromagnetic waves and receiving electromagnetic waves reflected by the object to generate the signal indicative of the distance between the object and the rear portion of the vehicle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a schematic representation of a vehicle including an advanced rear gate access system according to a principle of the present disclosure;

FIG. 2 is block diagram of the advanced rear gate access system, according to a principle of the present disclosure;

FIG. 3 is an example image that may be displayed on a display device of the vehicle providing a warning that opening a rear lift gate of the vehicle may result in contact with an object located proximate the vehicle;

FIG. 4 is another example image that may be displayed on a display device of the vehicle including an obstruction indicator that assists an operator of the vehicle in determining whether opening a rear lift gate of the vehicle may result in contact with an object located proximate the vehicle; and

FIG. 5 is a flow diagram of a method of operating of a rear closure assembly mounted to a rear portion of a vehicle, according to the present disclosure.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The present disclosure provides an advanced rear gate access system 102. A key function of system 102 is to provide a driver or another occupant of a vehicle 100 including the system 102 with an estimate of how far a rear lift gate 104 can open while operating the vehicle 100 in reverse and when parking the vehicle 100 near obstacles or other detected objects. The system 102 is configured to proactively scan behind the vehicle 100 to detect objects behind the vehicle 100 and provide the driver or occupant with a graphical representation of an opening clearance of the rear lift gate 104, which is then displayed on a display 106 located within vehicle 100.

In this manner, if the vehicle 100 is close enough to the obstacle or other detected object, the driver or occupant of the vehicle 100 will be notified via the display 106 that the rear lift gate 104 cannot fully open without contacting the obstacle or other detected object. Thus, based on the information that is visible on the display 106, the driver is able to position the vehicle 100 relative to the obstacle or other detected object in a manner such that a sufficient distance is between the obstacle or other detected object and the vehicle 100 where the rear lift gate 104 can be fully opened. Accordingly, the system 102 permits the driver of vehicle 100 to avoid having to exit the vehicle 100, learn that the vehicle 100 is too close to the object to fully open the rear lift gate 104, and then have to reenter the vehicle 100 and reposition the vehicle 100 to be a sufficient distance from the obstacle or other detected object to permit the rear lift gate 104 to fully open.

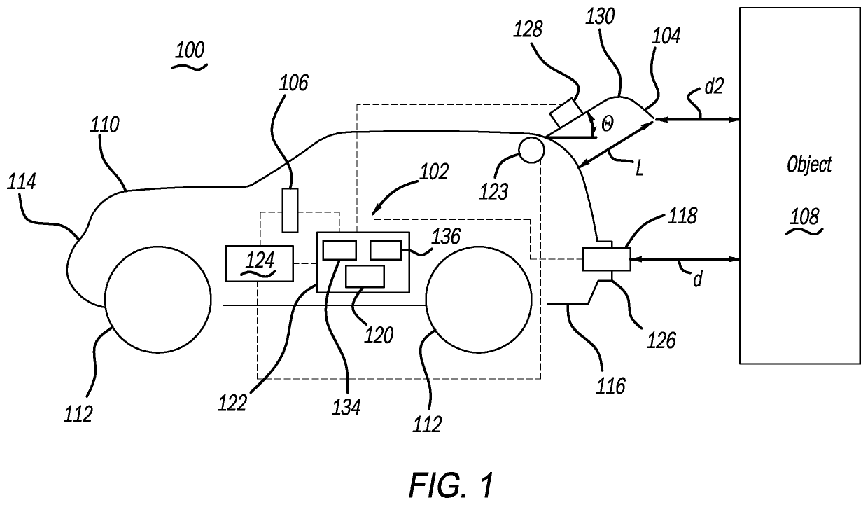

Referring now to the drawings, FIG. 1 provides an illustration of a vehicle 100 having advanced rear gate access system 102 that is configured to detect an obstacle or other object 108 located behind vehicle 100. Examples objects 108 that may be detected by system 102 include a wall, a garage door, a vehicle, a light pole, a tree, and other objects.

The vehicle 100 may be an autonomous, semi-autonomous or manually operated vehicle, and may also be fossil fuel powered (e.g., diesel, gasoline, natural gas), hybrid-electric powered, fully electric powered, or fuel cell powered. Vehicle 100 includes a vehicle body 110 and a plurality of wheels 112. The vehicle body 110 may include a front portion 114 and a rear portion 116, where rear portion 116 includes rear lift gate 104 that may open (as shown in FIG. 1) to expose an interior of vehicle 100 and close to prevent access to the interior of vehicle 100, as is known in the art. Rear lift gate 104 can be electrically powered to open and close, as is known in the art.

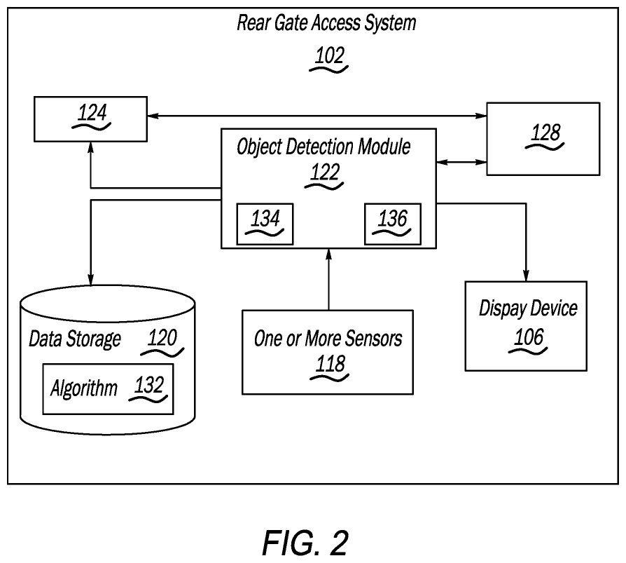

Referring to FIG. 2, rear gate access system 102 is illustrated. The rear gate access system 102 includes rear closure assembly or lift gate 104 (FIG. 1), one or more sensors 118, a data storage 120, an object detection module 122, and display device 106.

As noted above, the rear lift gate 104 may be a power lift gate that provides access to the interior of vehicle 100. The rear lift gate 104 may include an automated driving mechanism 123 such as a motor-driven telescoping control arm (not shown) that is operated by a vehicle controller 124. The rear lift gate 104 is movably mounted to vehicle body 110 by a pair of laterally spaced hinges (not shown) that allow the rear lift gate 104 to move or pivot about a pivot axis. While the example embodiment provides a powered lift gate 104, it should be understood that lift gate 104 manually operated between the closed position and the open position without departing from the scope of the present disclosure. In addition, it should be appreciated that the features of this disclosure may be applied to different vehicle closures assemblies, such as a cargo window, a trunk lid, a tailgate, a driver-side or passenger-side vehicle door, an engine hood, a convertible sunroof, and the like.

The one or more sensors 118 may be mounted to vehicle 100, for example, at or within a rear bumper 126. In another example, the one or more sensors 118 may be mounted at or within the rear lift gate 104. In either case, as best shown in FIG. 1, the one or more sensors 118 are configured to generate signals indicative of a distance d between the one or more sensors 118 and object 108.

In one example, the one or more sensors 118 may include one or more ultrasonic sensors configured to generate a signal indicative of the distance d between the vehicle 100 and the object 108 using ultrasonic sound waves. In this example, the one or more sensors 118 are configured to emit the ultrasonic waves in a planar cone-shaped array that can be applied to generate the signals indicative of the distance d in a horizontal direction. In this regard, the one or more sensors 118 are configured to emit the ultrasonic waves and then receive waves that are reflected back from object 108. The signal indicative of the distance d, in this example, is generated by calculating the amount of time that passes between the emission and reception of the waves, as is known in the art.

In another example, the one or more sensors 118 may include one or more radio detection and ranging (RADAR) sensors configured to detect a position of the object 108 by emitting electromagnetic waves (e.g., radio waves) and calculating the amount of time it takes for the waves to return to the one or more sensors 118 after being reflected by the object 108. The signal generated by such a sensor 118 may include data, in addition to the distance d between sensor 118 and the object 108, such as a direction of movement, velocity, and angular position of the object 108 in relation to the sensor 118.

In addition to the one or more sensors 118, it should also be understood that vehicle 100 may include a camera 128 that may be mounted to, for example, rear lift gate 104. Images captured by camera 128 may be communicated to either controller 124 or object detection module 122, which can then be communicated to display 106 to be viewed by the driver or occupant of vehicle 100 in real time.

The data storage 120 is configured to store data for use by rear gate access system 102 including, for example, one or more dimensions of the rear closure lift gate 104. In one example, the dimensions stored by data storage 120 include a length L of the rear lift gate 104. In addition, the dimensions stored by data storage 120 may include a dimension (e.g., radius of curvature) of any contours 130 that may be part of the rear lift gate 104. Other information that may be stored in data storage 120 can include a maximum opening angle Θ for rear lift gate 104 relative to rear 116 of vehicle 100. The maximum opening angle Θ of the rear lift gate 104 is an angle between the closed position and the maximum opened position of the rear lift gate 104.

Data storage 120 may also store algorithm 132. In one example, the algorithm 132 may be configured to correlate the distance d between the sensor(s) 118 and the obstacle 108 to a distance d2 between the rear lift gate 104 and the obstacle 108 at one or more predetermined open positions of the rear lift gate 104. For example, the distance d2 illustrated in FIG. 1 is a distance between the rear lift gate 104 and the obstacle 108 when the rear lift gate is at the maximum opening angle Θ. In addition, algorithm 132 may be configured to determine the maximum angle of clearance for rear lift gate 104, which is an amount of angle to be traveled by the rear lift gate 104 before rear lift gate 104 will contact the object 108. Put another way, based on, for example, the signals indicative of the distance d generated by sensor(s) 118 between vehicle 100 and object 108, the length L of rear lift gate 104, and the maximum opening angle Θ of rear lift gate 104, the algorithm 132 can be used to determine that if rear lift gate 104 is opened whether the rear lift gate 104 will contact object 108 when rear lift gate 104 is moved from the closed position to the open position.

Referring to FIG. 2, the object detection module 122 is electrically coupled to and in communication with the sensors 118 and the data storage 120. The object detection module 122 may be a high-definition multimedia interface-complaint device that includes one or more processing devices or processors 134 and memory or memory devices 136. Each processor 134 may include any type of device capable of processing electronic instructions including a microprocessor, microcontrollers, host processors, controllers, vehicle communication processors, and application specific integrated circuits (ASICs). The processor 134 is configured to execute various types of digitally stored instructions, such as software or firmware programs stored in memory 136, which enable a vehicle module to provide various services, functions and/or features.

Memory 136 may include any suitable computer usable or readable medium, which include one or more storage devices or articles. Exemplary computer usable storage devices induce conventional computer system RAM (random access memory), ROM (read only memory) EPROM (erasable, programmable ROM), EEPROM (electrically erasable, programmable ROM) and magnetic or optical disks or tapes. According to one or more forms, memory 136 may be categorized or divided into identifiable segments carrying or storing data or services—each segment having or being associated with a cell or address. At least some of the addresses may store sensitive or confidential information relating to the operation of vehicle 100, one or more users, and/or data and/or services.

Still referring to FIG. 2, the object detection module 122 is configured to receive from controller 124 data indicative of a direction of movement of vehicle 100 (e.g., whether vehicle 100 is moving forward or in reverse), a speed of vehicle 100, and a distance traveled by vehicle 100, and receive from the one or more sensors 118 signals indicative of the distance d as well as signals indicative of an angular position of object 108 in relation to the sensors 118. The object detection module 122 is configured to detect whether object 108 is within a predetermined range of the rear potion 116 of vehicle 100. The object detection module 122 is further configured to determine the distance d between the object 103 detected and the rear closure assembly 104 based on the sensed data.

The object detection module 122 is further configured to use algorithm 132 to determine whether the detected object 108 will inhibit (i.e., prevent) the rear lift gate 104 from moving between the closed position to the maximum open position based the distance d. If object detection module 122 determines that object 108 will contact rear lift gate 104 as the rear lift gate 104 is opened, the object detection module 122 is also configured to use algorithm 132 to determine the maximum opening angle that the rear lift gate 104 can open before contacting the object 108.

If the distance d between the rear lift gate 104 and the object 108 is sufficient to permit the rear lift gate 104 to move between the closed position to the maximum open position, the rear lift gate 104 is permitted to move from the closed position to the maximum open position based on a user-initiated request (i.e., by hitting a button (not shown) that instructs controller 124 to actuate driving mechanism 123). That is, object detection module 122 can send a signal to controller 124 that the distance d is sufficient to permit lift gate 104 to open, and then controller 124 is free to instruct driving mechanism 124 to actuate rear lift gate 104 upon the user-initiated request. On the other hand, if the distance d between the rear lift gate 104 and the object 108 is less than that required to permit the rear lift gate 104 to move from the closed position to the maximum open position, the object detection module 122 is configured communicate a signal to controller 124 that is indicative of it being unsafe to actuate rear lift gate 104 such that controller 124 will not instruct actuation mechanism 123 to move rear lift gate 104. In this manner, damage to rear lift gate 104 that may occur due to contact between rear lift gate 104 and object 108 as rear lift gate 104 is opened can be avoided.

If object 108 would inhibit the rear lift gate 104 from moving to the maximum open position, the object detection module 122 is configured to use algorithm 132 to determine one or more points of contact between the rear lift gate 104 and the detected object 108 based on the distance d between the detected object 108 and the rear lift gate 104. Additionally, if the rear lift gate 104 would be inhibited from moving to the maximum open position, the object detection module 122 is configured to alert the driver or occupant of vehicle 100.

In this regard, display device 106 is in communication with the object detection module 122 via controller 124, and may be, for example, a high-definition multimedia interface (HDMI) display. The display device 106 may also be configured to receive and display uncompressed video data and/or compressed or uncompressed digital audio data from camera 128, either directly from camera 128 or via controller 124. In one form, display device 112 may include a display controller (not shown) and a monitor for displaying images.

Display device 106 is configured to alert a driver or occupant of vehicle 100 when the detected object 108 is near the rear portion 116 of the vehicle 100. In one form, the display device 106 is configured to provide a two-dimensional graphical representation of the rear lift gate 104 in the maximum opening position relative to the detected object 108. For example, display device 106 can display an image similar to FIG. 1 where rear lift gate 104 is displayed to the driver or occupant of vehicle 100 safely in the maximum open position relative to object 108.

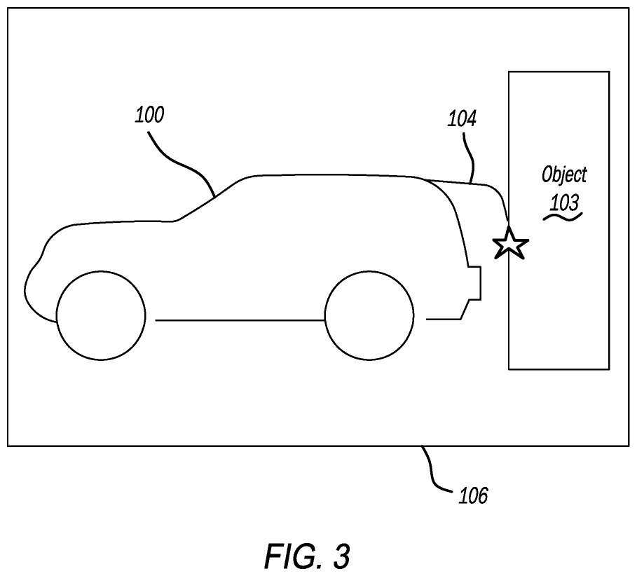

Similarly, referring to FIG. 3, display device 106 is configured to provide a digital image of the rear lift gate if the object 108 will obstruct the rear lift gate 104 from moving between the closed position to the maximum open position. As can be seen in FIG. 3, the digital image reflects that if rear lift gate 104 is desired to be opened, the rear lift gate 104 will contact the object 108. The digital images displayed by display device 106 may further include the distance d as determined by system 102 between the detected object 108 and the rear lift gate 104 (see, e.g., FIG. 1).

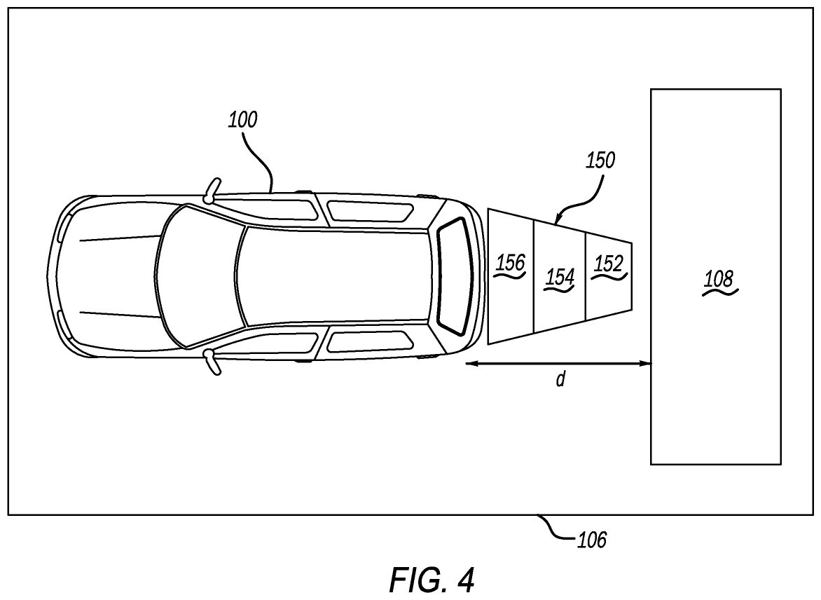

In addition, as best shown in FIG. 4, the digital image displayed by display device 106 may be an overhead view of vehicle 100 relative to object 108 and include an obstruction indicator 150. In one example, the obstruction indicator 150 may be a digital image of at least three visual color zones 152, 154, 156. More specifically, the obstruction indicator 150 may include a first zone 152 that may be green, a second zone 154 that may be yellow, and a third zone 156 that may be red. Each zone 152, 154, and 156 is configured to provide a visual representation of whether it is safe or not safe to open rear lift gate 104 in relation to the object 108. For example, based on the distance d illustrated in FIG. 4, the first (green) zone 152 indicates that vehicle 100 is located at a safe distance from object 108 where rear lift gate 104 can be safely opened to the maximum open position. The second (yellow) zone 154 indicates that if vehicle 100 is moved closer to object 108, opening of the rear lift gate 104 to the maximum open position can be accomplished, but the rear lift gate 104 may be very close to object 108. The third (red) zone 156 indicates that if the rear lift gate 104 is attempted to be opened to the maximum open position the rear lift gate 104 will contact the object 108 and be prevented from opening to the maximum opening position.

In combination with the images shown in FIGS. 1 and 4, or in alternative to the images shown in FIGS. 1 and 4, it should be understood the display device 106 may be configured to simply provide an audible alarm. In such an example, vehicle 100 would require a speaker (not shown) or display device 106 may be provided with a speaker (not shown). In any event, for example, display device 106 can provide a series of sounds (e.g., beeps) that increase in frequency as vehicle 100 approaches object 108. Once vehicle 100 is too close to object 108 to open rear lift gate 104 without contact, a continuous audible sound may be omitted.

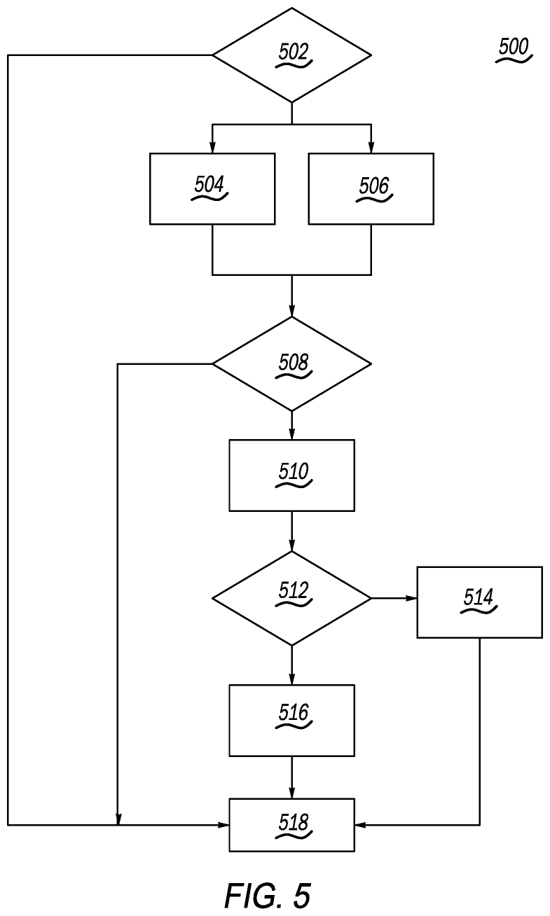

Now referring to FIG. 5, an example method 500 of using rear gate access system 102 is illustrated. At step 502, object detection module 122 can communicate with controller 124 and determine whether vehicle 100 is being operated in reverse. If vehicle 100 is operating in reverse, object detection module 122 can communicate with the one or more sensors 118 (step 504) and optionally the camera 128 (step 506) to determine whether an object 108 is present in the path of moving vehicle 100 in reverse (step 508). If camera 128 is being used at this time, an image of the path behind vehicle 100 can be displayed on display device 106. If vehicle 100 is not being operated in reverse, the method may proceed to end at 518. In addition, if no object is detected by sensors 118 and/or camera 128 at step 508, the method may proceed to end at 518.

If an object 108 is detected by sensor(s) 118 and/or camera 128 at step 508, object detection module 122 can, based on signals received from sensors 118 that are indicative of the distance d between vehicle 100 and object 108, determine a maximum angle for clearance based on the distance d between the detected object 108 and the rear 116 of vehicle 100 and display device 106 may display an image like that shown in FIG. 4 (i.e., including obstruction indicator 150) (step 510). At 512, the object detection module 122 can also determine whether the detected object 108 will inhibit the rear lift gate 104 from moving from the closed position to the maximum open position. If yes, display device 106 can generate an alarm (i.e., continuous sound) that indicates that is unsafe to actuate rear lift gate 104 from the closed position to the open position (step 514). If no, object detection module 122 can communicate a signal to controller 124 that will not prevent controller 124 from actuating rear lift gate 104 based on a user-initiated request (step 516). The method may end at 518.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A vehicle comprising:
a vehicle body having a front portion and a rear portion;
a movable enclosure attached to the rear portion of the vehicle that is configured to move between a closed position and a maximum open position; and
a movable enclosure access system that is configured to determine whether an object is located proximate to the rear portion of the vehicle that would inhibit the movable enclosure from moving between the closed position and the maximum open position,
wherein the movable enclosure access system includes at least one sensor that is configured to generate a signal indicative of a distance between the object and the rear portion of the vehicle;
the movable enclosure access system includes an object detection module including a memory and a processor that is in communication with the at least one sensor; and
based on the signal indicative of the distance between the object and the rear portion of the vehicle, the objection detection module is configured to determine whether the distance between the object and the rear portion of the vehicle is sufficient to permit the movable enclosure to move between the closed position and the maximum open position without contacting the object, and to determine a maximum opening angle that the movable enclosure can open before contacting the object

2. The vehicle according to claim 1, wherein the movable enclosure access system further includes a camera and a display device configured to display images captured by the camera.

3. The vehicle according to claim 2, wherein in addition to the images captured by the camera, the display device is configured to display an obstruction indicator that is configured to provide a visual indication of whether the distance between the object and the rear portion of the vehicle is sufficient to permit the movable enclosure to move between the closed position and the maximum open position without contacting the object.

4. The vehicle according to claim 3, wherein the obstruction indicator includes at least three visual color zones.

5. The vehicle according to claim 1, further comprising a controller in communication with a driving mechanism that, based on an instruction received from the controller, is configured to move the movable enclosure between the closed and maximum open positions;
the controller is in communication with the object detection module;
the objection detection module is configured to communicate the determination whether the distance between the object and the rear portion of the vehicle is sufficient to permit the movable enclosure to move between the closed position and the maximum open position without contacting the object; and
based on the communication received from the objection detection module, the controller is configured to permit or prevent the movable enclosure from moving between the closed position and the maximum open position.

6. The vehicle according to claim 1, wherein the movable enclosure access system includes a data storage that stores an algorithm and that can be accessed and executed by the processor, and when the algorithm is executed by the processor, the objection detection module is configured to determine whether the movable enclosure will contact the object when the movable enclosure is moved between the closed position to the maximum open position.

7. The vehicle according to claim 1, wherein the data storage is configured to store information directed to dimensions of the movable enclosure.

8. The vehicle according to claim 1, wherein the at least one sensor includes an ultrasonic sensor configured to emit ultrasonic waves and receive ultrasonic waves reflected by the object to generate the signal indicative of the distance between the object and the rear portion of the vehicle.

9. The vehicle according to claim 1, wherein the at least one sensor includes a radar sensor configured to emit electromagnetic waves and receive electromagnetic waves reflected by the object to generate the signal indicative of the distance between the object and the rear portion of the vehicle.

10-16. (canceled)

17. The vehicle according to claim 4, wherein the images captured by the camera and displayed by display device are overhead views of the vehicle relative to the object,
the obstruction indicator provided in the overhead views includes a first visual color zone, a second visual color zone attached to the first visual color zone, and a third visual color zone attached to the second visual zone, and
the first visual color zone is located further away from the vehicle in the images in comparison to the second visual color zone, which is located further away from the vehicle in comparison to the third visual color zone.
